(19) United States
(12) Patent Application Publication
(10) Pub. No.: US 2004/0144629 A1
(43) Pub. Date: Jul. 29, 2004

(54) Latching mechanism for locking a spring energy store

(76) Inventors: J?ouml;rg-Uwe Dahl, (US); Ludvik Godesa, Berlin (DE); Ralph Hohenberger, Brieselang (DE); Marc Liebetruth, Glienicke (DE)

Correspondence Address: HARNESS, DICKEY & PIERCE, P.L.C., P.O.BOX 8910, RESTON, VA, 20195, US

(21) Appl. No.: 10/475,609

(22) PCT Filed: Mar. 26, 2002
(86) PCT No.: PCT/DE02/01156

(30) Foreign Application Priority Data
Apr. 23, 2001 (DE) 101 20 783.2

(51) Int. Cl. H01H 9/28

(52) U.S. Cl. 200/43.16

(57) ABSTRACT

The invention-relates to a latching mechanism for locking a spring energy store (1) of an electric switching device, said store being tensioned by a rotary drive (10 and 11) and an extensible lever system (2, 3 and 4). In said latching mechanism, the extensible lever system is locked with the spring energy store under tension by means of a support clement (12), an auxiliary lock (14) and a primary lock (16), in addition to a stop (17) that is allocated to the primary lock (16), whereby the auxiliary lock (14) can be pivoted by the extension of the lever system and the position of the primary lock (16) during the pivoting of the auxiliary lock (14) can be influenced by working surfaces that are allocated to one another. To configure the locking mechanism for pivoting the primary lock (16) in a manner which obviates the use of a return spring that acts on said primary lock, the auxiliary lock (14) and the primary lock (16) respectively have at least two working surfaces (24, 25 and 26, 27). In a first pivoting phase of the auxiliary lock, the respective first surfaces of the two sets of working surfaces (24 and 26) lie adjacent to one another and in a second pivoting phase of the auxiliary lock, the second working surfaces (25 and 27) lie adjacent to one another, intermeshing in the manner of a toothed gear.

The invention lies in the area of electrical switches equipped with a spring-powered drive for actuating contacts, and is to be used for the configuration of a latching mechanism for locking a spring energy store.

In the case of a known latching mechanism for a spring-powered drive, in which the associated spring energy store is tensioned by means of a rotary drive and an extensible toggle lever system, the extensible toggle lever system is locked with the spring energy store under tension by means of a support element, an auxiliary lock and a primary lock in addition to a stop allocated to the primary lock. In the case of this latching mechanism, in which the supporting element designed as a lever is articulated on the one hand on the toggle joint of the toggle lever system and on the other hand on the auxiliary lock, the auxiliary lock can be pivoted by extension of the lever system. In this case, the auxiliary lock and the primary lock have working surfaces allocated to one another, by means of which the position of the primary lock during the pivoting of the auxiliary lock can be influenced (DE 44 16 088 C1). In this case, a first working surface of the auxiliary lock is formed by a semicircular portion of the peripheral edge of the auxiliary lock which lies adjacent to a working surface of the primary lock designed as a roller, and keeps the primary lock in a first position counter to the force of the return spring allocated to it. In this first position, a half-shaft forming the stop is locked by the primary lock under spring pretension. A second working surface, which is designed as a set-back edge and is likewise allocated to the roller, releases the primary lock at the end of the tensioning operation, so that on the one hand the primary lock pivots under the force of the return spring allocated to it in overtravel behind the half-shaft and on the other hand the released half-shaft pivots on account of its spring pretension into the path of movement of the primary lock. Both pivoting operations must proceed before the primary lock pivots in the reverse direction by decoupling of the lever system from the rotary drive under the effect of the force of the spring energy store. Since an indicating element for the state of the spring energy store is usually coupled to the primary lock, it is at the same time expedient with regard to the certainty of the indication that the primary lock pivots in overtravel behind the half-shaft only shortly before the decoupling of the lever system from the rotary drive. For this purpose, rapid movements of the latching mechanism are required, in particular when there is a high energy content of the spring energy store. —In the case of the said latching mechanism, the return spring allocated to the primary lock must therefore provide a correspondingly high returning force. This returning force is then in turn to be taken into account when configuring the latching mechanism with regard to its force reduction and when configuring the mechanisms providing the triggering force for releasing the locking.

To lock the tensioned spring energy store securely, it is necessary in particular for the tolerance range of the force under which the primary lock lies adjacent to the stop and the tolerance range of the force which is necessary for releasing the locking to be adapted to the tolerance range of the return spring. If there is a rupture of the return spring allocated to the primary lock, locking of the tensioned spring energy store is not possible. On the basis of a latching mechanism with the features of the precharacterizing clause of claim 1 (DE 44 16 088 C1), the invention is based on the object of configuring the latching mechanism for pivoting the primary lock in a manner which obviates the use of a return spring which acts on the primary lock.

According to the invention, this object is achieved by the auxiliary lock and the primary lock respectively having at least two working surfaces, wherein, in a first pivoting phase of the auxiliary lock, respective first surfaces of the two sets of working surfaces lie adjacent to one another and, wherein, in a second pivoting phase, the second working surfaces lie adjacent to one another, intermeshing in the manner of a toothed gear.

On account of a configuration of this type, it is ensured that the primary lock is forcibly pivoted at the end of the tensioning operation to the extent that it reliably comes into adjacent contact with the stop under the effect of the force of the spring energy store when the lever system is decoupled from the rotary drive. Since, in particular when there is a high energy content of the spring energy store, no high returning forces have to be taken into account in the configuration of the latching mechanism, both a low tolerance range of the force under which the primary lock lies adjacent to the stop and a low tolerance range of the triggering force can be provided.

There is in fact a known latching mechanism for locking a spring energy store, in which a primary lock can be pivoted without using a return spring acting on the primary lock (DE 37 33 916 A1). —In the case of this known latching mechanism, the primary lock is moved by an extensible lever system—without an auxiliary lock being interposed—and is thereby transferred in particular in overtravel behind a stop allocated to the primary lock.

An expedient development of the novel latching mechanism provides that on the one hand the first working surface of the auxiliary lock is formed by a pin of the auxiliary lock protruding transversely with respect to the pivoting plane and the second working surface of the auxiliary lock is formed by a concavely shaped portion of the peripheral edge of the auxiliary lock, and that on the other hand the first working surface of the primary lock is formed by a lug of the primary lock and the second working surface is formed by a roller held on the primary lock.

In order when tensioning the spring energy store to transmit part of the force of the rotary drive and when detensioning the spring energy store to transmit part of the force of the spring energy store uniformly to the auxiliary lock in a space that is as small as possible, in a further refinement of the invention it is provided that, in the case of the locked position of the lever system, a roller which forms the supporting element and is arranged on a joint bolt of the lever system lies adjacent to a second concavely shaped portion of the peripheral edge of the auxiliary lock.

Furthermore, at the end of the tensioning phase, a small amount of travel which transmits from the rotary drive to the lever system can be converted into a large, and consequently abrupt, pivoting movement of the auxiliary lock, independently of the pivoting movement of the supporting element coupled to the lever system, if in a further refinement of the invention a driver coupled to the lever system and a two-armed pivotable control lever are provided for controlling the pivoting movement of the auxiliary lock, the first lever arm of the control lever protruding into an end portion of the path of movement of the driver and the second lever arm being allocated to a driving surface of the auxiliary lock. —For controlling the auxiliary lock, in addition to the first driver and the control lever there may be provided a second driver, which is coupled to the lever system and during the extension of the lever system lies adjacent over a portion of its path of movement to a second driving surface of the auxiliary lock. Maintaining a form of construction of the latching mechanism that is as small as possible is in this case made possible by the fact that the first driver is formed by the joint bolt of the lever system, the joint bolt being allocated a lug-like projection of the control lever as its first lever arm and there being formed on the second lever arm of the control lever a pin which engages in a slot which is formed close to the pivot point of the auxiliary lock and the inner edge of which forms the first driving surface. —The second driver may be designed as a bolt which forms the toggle joint of a toggle lever connection coupled to the lever system, the second driving surface being formed by a further portion of the peripheral edge of the auxiliary lock.

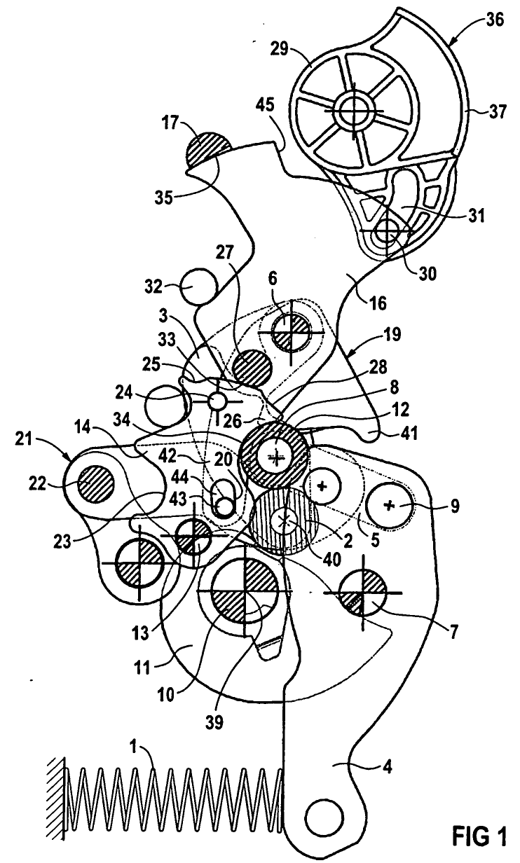

An exemplary embodiment of the novel latching mechanism is represented in FIGS. 1 to 7, in which:

FIG. 1 shows the latching mechanism with the spring energy store fully relaxed,

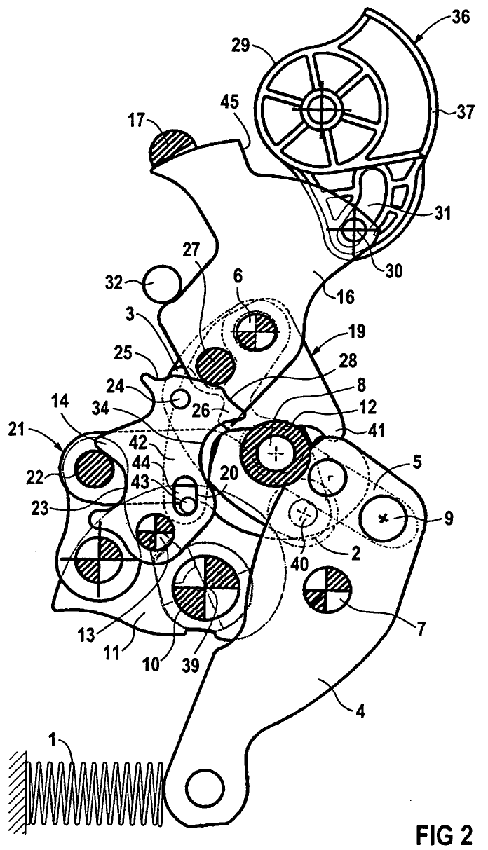

FIGS. 2 to 6 show the latching mechanism in five different phases of the tensioning process and

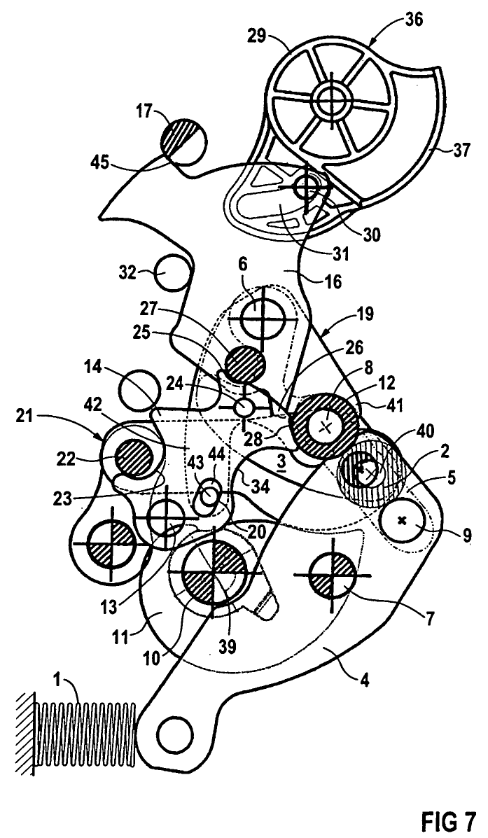

FIG. 7 shows the latching mechanism with the spring energy store completely tensioned and locked.

FIGS. 1 to 7 show a latching mechanism integrated into a drive device for a low-voltage circuit breaker. The drive device, which serves for the actuation of a switching contact arrangement not represented in the figures, has in this case a spring energy store 1, designed as a helical compression spring, for providing the actuating energy. Provided in the case of this drive device for tensioning the spring energy store 1 is a lever system which can be extended by means of a rotary drive and for the locking of which the latching mechanism serves. —The lever system is in this case formed by a roller lever 3 bearing a sensing roller 2, a tensioning lever 4 articulated on the spring energy store 1 and a coupling element 5 connecting the roller lever 3 to the tensioning lever 4. The roller lever 3 is pivotably arranged on a first bearing bolt 6 and the tensioning lever 4 is pivotably arranged on a second bearing bolt 7. In this case, the roller lever 3 and the coupling element 5 are connected by means of a first joint bolt 8 and the tensioning lever 4 and the coupling element 5 are connected by means of a second joint bolt 9. The tensioning lever 4 is designed as a two-armed lever, the one arm being articulated on the coupling element 5 and the other arm being articulated on the spring energy store 1. Of the rotary drive, which may be operated for example by an electric motor and/or by means of a hand lever, only a tensioning shaft 10 which can rotate clockwise and a cam disk 11 which is fixedly arranged on the tensioning shaft 10 are respectively shown in FIGS. 1 to 7.

The cam disk 11 and the lever system 3, 4 and 5 are coupled for the transmission of the driving force of the rotary drive as soon as the sensing roller 2 borne by the roller lever 3 lies adjacent to the peripheral edge of the cam disk 11.

The latching mechanism has, on the one hand, for locking the lever system, a supporting element, which is designed as a roller 12, an auxiliary lock 14, which is pivotable about a third bearing bolt 13, a primary lock 16, which is pivotable about the first bearing bolt 6, and also a stop 17, which is allocated to the primary lock 16, and, on the other hand, for controlling the pivoting movement of the auxiliary lock 14, a first driver, which is formed by the first joint bolt 8 of the lever system—and acts via a two-armed control lever 19 on a first driving surface 20 of the auxiliary lock 14—and a second driver 22, which forms the toggle joint of a toggle lever connection 21 coupled to the lever system—and acts directly on a second driving surface 23 of the auxiliary lock 14. To influence the pivoting movement of the primary lock 16 during the pivoting of the auxiliary lock 14, on the one hand a first working surface, formed by a pin 24, and a second working surface, formed by a first concavely shaped portion 25 of the auxiliary lock, are provided on the auxiliary lock 14, and on the other hand a first working surface, allocated to the pin 24 and formed by a lug 26 of the main lock, and a second working surface, allocated to the first concavely shaped portion 25 and formed by a roller 27 held on the primary lock, are provided on the primary lock 16. In this case, during the clockwise pivoting of the auxiliary lock 14 (i.e. under the effect of the force of the rotary drive 10 and 11), the primary lock 16 is turned counterclockwise as soon as firstly the pin 24 and the lug 26 and later, intermeshing in the manner of a toothed gear, the first concavely shaped portion 25 of the peripheral edge of the auxiliary lock and the roller 27 lie adjacent to one another. The lever system 3, 4 and 5 is locked as soon as the roller 12 forming the supporting element and arranged on the first joint bolt 8 of the lever system lies adjacent to a second concavely shaped portion 28 of the peripheral edge of the auxiliary lock, the first concavely shaped portion 25 of the auxiliary lock lies adjacent to the roller 27 of the primary lock and the primary lock 16 lies adjacent to the stop 17 designed as a half-shaft. Coupled to the primary lock is an indicating element 29, which signals the state of the spring energy store. For this purpose, a pin 30 formed on the primary lock engages in a curved slot 31 of the indicating element 29 in such a way that, when the auxiliary lock 16 pivots, the indicating element pivots along with it.

FIG. 1 shows the latching mechanism before the beginning of the tensioning process. At this point in time, the cam disk 11 is in its starting position and the sensing roller 2 borne by the roller lever 3 lies adjacent to the peripheral edge of the cam disk 11.

The lever system 3, 4 and 5 is in a first position, in which the spring energy store 1 is completely relaxed. In this case, the primary lock 16 is supported on a stop bolt 32, the auxiliary lock 14 is supported by means of a straight portion 33 of its peripheral edge adjacent to the roller 27 of the primary lock 16 on the primary lock 16, and the roller 12 coupled to the lever system 3, 4 and 5 and forming the supporting element is supported on a third concavely shaped portion 34 of the peripheral edge of the auxiliary lock. A portion 35 of the peripheral edge of the primary lock 16 in this case lies underneath the half-shaft 17 in such a way that the half-shaft 17—which is rotatable by means of triggering mechanisms not represented any further against the force of a return spring likewise not represented—is held under spring pretension. The indicating element 29, which is coupled to the primary lock 16 and provided with an indicating surface 36, is in this case in a first position, in which a first subregion 39 of the indicating surface 36 of the indicating element lies opposite a viewing window not represented. This first subregion 37 signals that the spring energy store 1 is not completely tensioned. A symbol suitable for this is, for example, a compression spring shown relaxed. At the point in time represented in FIG. 1, neither does the first driver 18 lie adjacent to the control lever 19 nor does the second driver 22 lie adjacent to the second driving surface 23 of the auxiliary lock.

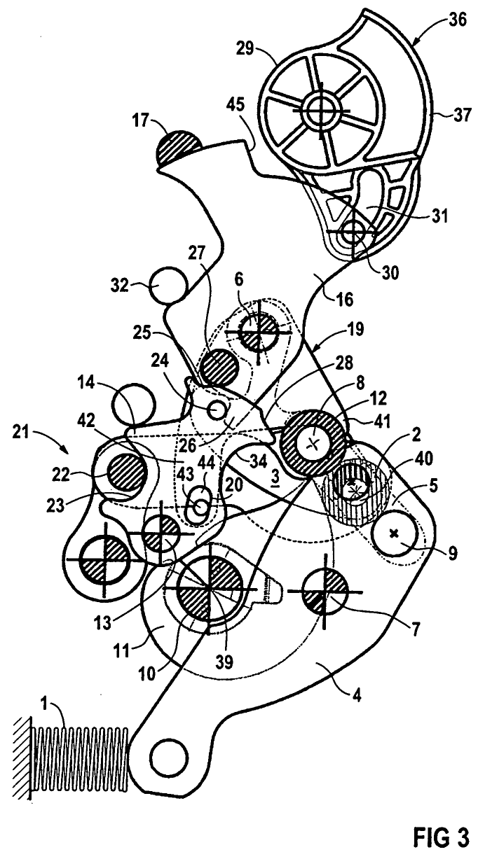

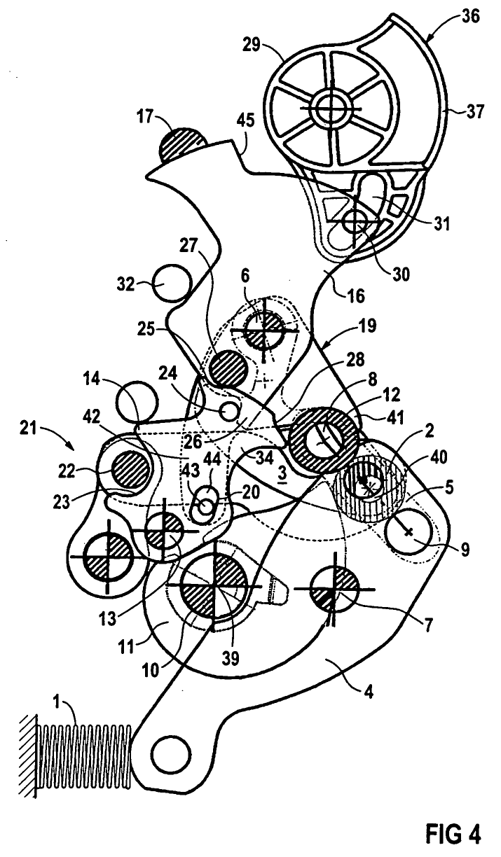

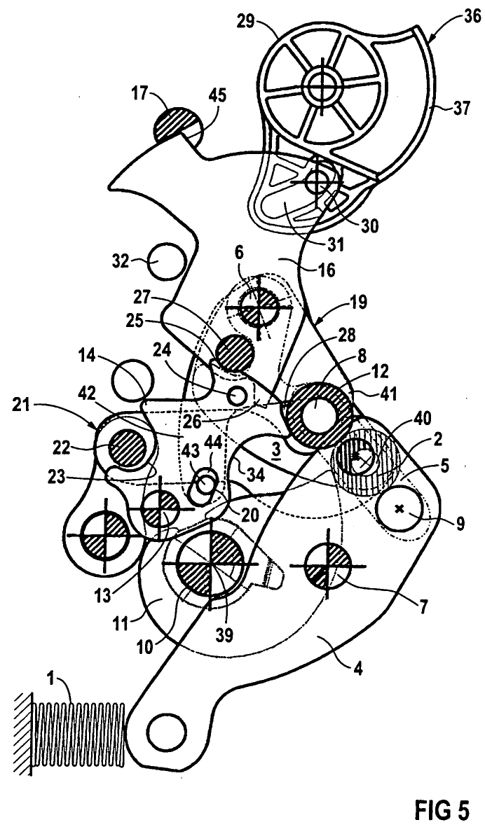

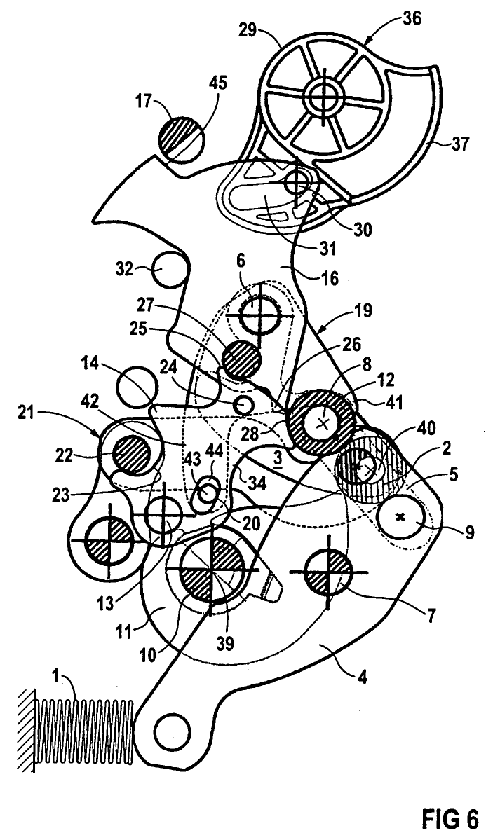

According to FIGS. 2 to 6, which show the latching mechanism during various phases of the tensioning process, the lever connection of the lever system formed by the roller lever 3 and the coupling element 5 is established by the bolt 40, bearing the sensing roller, and consequently also the roller lever 3, pivoting counterclockwise as the distance of the peripheral edge of the cam disk 11 from the pivot point of the cam disk increases. The movement of the roller lever 3 is transmitted by means of the coupling element 5 to the tensioning lever 4, so that the arm of the tensioning lever articulated on the spring energy store 1 is pivoted clockwise about the second bearing bolt 7 and the spring energy store 1 is thereby tensioned. At the point in time represented in FIG. 1, the second driver 22 comes into adjacent contact with the second driving surface 23 of the auxiliary lock and pivots the auxiliary lock 14 clockwise about the third bearing bolt 13 until, according to FIG. 3, the pin 24 which is formed on the auxiliary lock 14 and protrudes from the auxiliary lock perpendicularly with respect to the pivoting plane of the auxiliary lock runs against the lug 26 formed on the primary lock 16. At this point in time, the first driver 20 runs against a first arm 41, protruding into an end portion of its path of movement and formed as a lug-like projection of the control lever, and pivots the control lever counterclockwise about its pivot point formed by the first bearing bolt 6. This pivoting movement is transmitted to the auxiliary lock via the second arm 42 of the control lever, which is made longer than the first arm. For this purpose, a control pin 43 protruding from the control lever transversely with respect to the pivoting direction of the control lever is arranged at the end of the longer, second arm 42 of the control lever 19. This control pin 43 protrudes into a second curved slot 44, which is formed close to the third bearing bolt 13 (pivot point of the auxiliary lock) and the inner edge of which forms the second driving surface of the auxiliary lock. Since the distances of the working surfaces 24 and 25, formed on the auxiliary lock 14, from the pivot point of the auxiliary lock 13 are greater than the distance of the control pin 43 of the control lever from the pivot point of the auxiliary lock 13, and since furthermore the distances of the working surfaces of the primary lock 26 and 27 from the first bearing bolt 6 (pivot point of the primary lock) are less than the stance of a portion 45 of the peripheral edge of the auxiliary lock that is allocated to the stop 17 from the pivot point of the primary lock, according to FIGS. 3 to 6 at the end of the tensioning process a small arc length of the pivoting movement of the first driver 8 is converted into a large arc length of the pivoting movement of the portion 45 of the peripheral edge of the primary lock that is allocated to the stop. For this purpose, in a first pivoting phase according to FIGS. 3 and 4, the first working surfaces 24 and 26 of the auxiliary lock and of the primary lock respectively lie adjacent to one another. During the transition into a second pivoting phase of the auxiliary lock—in which according to FIGS. 5 and 6 the second working surfaces 25 and 27 lie adjacent to one another, intermeshing in the manner of a toothed gear—they are decoupled from one another. In this second pivoting phase of the auxiliary lock, the portion 45 of the peripheral edge of the primary lock that is allocated to the stop passes in overtravel behind the stop 17 shortly before the sensing roller 2 of the roller lever 3 is decoupled from the peripheral edge of the cam disk 11.

According to FIG. 7, which shows the latching mechanism with the spring energy store 1 completely tensioned and locked, the lever system, decoupled from the rotary drive, is supported under the force of the spring energy store 1 via the supporting element 12, coupled to the lever system, on the third concavely shaped portion 34 of the peripheral edge of the auxiliary lock, the rotary lock 14 is supported via the second working surfaces 25 and 27 on the primary lock 16 and the primary lock is supported on the stop 17. At this point in time, the indicating element 29, coupled to the primary lock, is in a second position, in which a second subregion 38 of the indicating surface 36 lies opposite the viewing window. This second subregion 38 signals that the spring energy store 1 is completely tensioned. A symbol suitable for this is, for example, a compression spring shown tensioned.

To keep the play between the mutually allocated working surfaces of the auxiliary lock and of the primary lock as small as possible, a spring acting on the primary lock may be provided, for example.

List of Designations

1 Spring energy store

2 Sensing roller

3 Roller lever

4 Tensioning lever

5 Coupling element

6 First bearing bolt (bearing bolt of the roller lever of the primary lock and of the two-armed control lever)

7 Second bearing bolt (bearing bolt or pivot point of the tensioning lever)

8 First joint bolt; forms the first driver

9 Second joint bolt (joint bolt between tensioning lever and coupling element)

10 Tensioning shaft

11 Cam disk

12 Roller which forms the supporting element

13 Third bearing bolt (bearing bolt or pivot point of the auxiliary lock)

14 Auxiliary lock

16 Primary lock

17 Stop

19 Two-armed control lever

20 First driving surface of the auxiliary lock

21 Toggle lever connection

22 Second driver

23 Second driving surface

24 Pin (first working surface of the auxiliary lock)

25 First concavely shaped portion of the peripheral edge of the auxiliary lock (second working surface of the auxiliary lock)

26 Lug of the primary lock (first working surface of the primary lock)

27 Roller held on the primary lock (second working surface of the roller)

28 Second concavely shaped portion of the peripheral edge of the auxiliary lock

29 Indicating element

30 First curved slot of the indicating element

32 Stop bolt

33 Straight portion of the peripheral edge of the auxiliary lock

34 Third concavely shaped portion of the peripheral edge of the auxiliary lock

35 Portion formed on the peripheral edge of the primary lock

36 Indicating surface of the indicating element

37 First subregion of the indicating surface

38 Second subregion of the indicating surface

39 Pivot point of the cam disk

40 Bolt which bears the sensing roller

41 First arm of the two-armed control lever

42 Second arm of the control lever

43 Control pin

44 Second curved slot, which is formed in the auxiliary lock

45 Portion of the peripheral edge of the primary lock that is allocated to the stop

1. A latching mechanism for locking a spring energy store (1) of an electrical switch tensioned by means of a rotary drive (10, 11) and an extensible lever system (3, 4, 5),
in which the extensible lever system (3, 4, 5) is locked with the spring energy store (1) under tension by means of a support element, (12) an auxiliary lock (14) and a primary lock (16) in addition to a stop (17) allocated to the primary lock,
wherein the auxiliary lock (14) can be pivoted by extension of the lever system and
wherein the auxiliary lock and the primary lock have working surfaces allocated to one another, by means of which the position of the primary lock during the pivoting of the auxiliary lock can be influenced, characterized
in that the auxiliary lock and the primary lock respectively have at least two working surfaces (24, 25; 26, 27),
wherein, in a first pivoting phase of the auxiliary lock, respective first surfaces of the two sets of working surfaces (24, 26) lie adjacent to one another and
wherein, in a second pivoting phase, the second working surfaces (25, 27) lie adjacent to one another, intermeshing in the manner of a toothed gear.

2. The latching mechanism as claimed in claim 1, characterized in that the first working surface (24) of the auxiliary lock (14) is formed by a pin of the auxiliary lock protruding transversely with respect to the pivoting plane and the second working surface (25) of the auxiliary lock is formed by a concavely shaped portion of the peripheral edge of the auxiliary lock, and
in that the first working surface (26) of the primary lock (16) is formed by a lug of the primary lock and the second working surface (27) is formed by a roller held on the primary lock.

3. The latching mechanism as claimed in claim 1 or 2, characterized in that, in the case of the locked position of the lever system (3, 4, 5), a roller which forms the supporting element (12) and is arranged on a joint bolt (8) of the lever system lies adjacent to a second concavely formed portion of the peripheral edge of the auxiliary lock (28).

4. The latching mechanism as claimed in one of claims 1 to 3, characterized in that a driver (8) coupled to the lever system and a two-armed pivotable control lever (19) are provided for controlling the pivoting movement of the auxiliary lock (14),
the first lever arm (41) of the control lever (19) protruding into an end portion of the path of movement of the driver (8) and the second lever arm (42) being allocated to a driving surface (20) of the auxiliary lock (14).

5. The latching mechanism as claimed in one of claim 4, characterized in that a second driver (22), which is coupled to the lever system and during the extension of the lever system lies adjacent over a portion of its path of movement to a second driving surface (23) of the auxiliary lock, is provided for controlling the pivoting movement of the auxiliary lock (14).

6. The latching mechanism as claimed in one of claims 4 or 5, characterized in that the first driver is formed by the joint bolt (8) of the lever system, the joint bolt (8) being allocated a lug-like projection of the control lever as its first lever arm (41), and
there being formed on the second lever arm (42) of the control lever a pin (43) which engages in a slot (44) which is formed close to the pivot point of the auxiliary lock and the inner edge of which forms the first driving surface (20).

7. The latching mechanism as claimed in one of claims 5 or 6, characterized in that the second driver (22) is designed as a bolt which forms the toggle joint of a toggle lever connection (21) coupled to the lever system and
in that the second driving surface (23) is formed by a further portion of the peripheral edge of the auxiliary lock.
